(19) United States
(12) Patent Application Publication
(10) Pub. No.: US 2017/0169348 A1
(43) Pub. Date: Jun. 15, 2017

(54) EXTRACTION OF PATENTS USING TREND ANALYSIS

(71) Applicant: INTERNATIONAL BUSINESS MACHINES CORPORATION, Armonk, NY (US)

(72) Inventors: Shoko Suzuki, Kanagawa (JP); Hiromichi Takatsuka, Kanagawa (JP)

(21) Appl. No.: 14/965,476

(22) Filed: Dec. 10, 2015

(51) Int. Cl. G06N 5/04; G06F 17/30

(52) U.S. Cl. CPC G06N 5/048; G06F 17/30011

(57) ABSTRACT

A method for measuring technology trends that includes providing from a plurality of inventors in a technology field a baseline of technical documents published in a time period, and detecting a number of technical document publications having at least one inventor in the plurality of inventors in the technology field. The method further includes comparing the number of technical document publications to the baseline of technical documents published in the time period. If the technical document publications exceed the baseline, the number of technical document publications are trending. Comparative analysis of the content for the technical document publications that are trending determines a measurement of similarity in technical field subgroups. Trending technical subgroups are extracted from the technical document publications that are trending with a degree of similarity above a threshold as a target technical group that is a trend.

### BACKGROUND

Technical Field

The present disclosure relates to determining technology trends from published patent applications.

Description of the Related Art

Research initiatives are normally closely held corporate secrets. Insights to research trends are difficult to extract from public information. Patent applications which are examined and approved in parent systems have a key role in the industry of each country. In some examples, industries can not grow or thrive without patenting their important inventions. Data mining of patent documents provides an opportunity to expose interesting trends and areas of interest as indicated by activity in patent areas.

### SUMMARY

In one embodiment, the present disclosure provides a method to detect important technologies in a technological field. In one embodiment, the method includes analyzing for each inventor of a plurality of inventors in a technology field, a time series of publication dates for technical documents in the technology field to provide a baseline of technical documents published in a time period. The method may continue with detecting with a hardware processor based counter a number of technical document publications having at least one inventor in the plurality of inventors in the technology field. The number of technical document publications may be compared to the baseline of technical documents published or applied (submitted) in the time period. If the technical document publications exceed the baseline of technical documents, the number of technical document publications is trending. A comparative analysis may be conducted for the content for of the technical document publications that are trending to determine a measurement of similarity in technical subgroups described in the technical document publications that are trending. If the technical subgroups that are trending having a degree of similarity above a threshold value, the trending technical subgroups are extracted from the technical document publications as a measurable trend.

In another embodiment, a system is provided for detecting important technologies in a technological field. In one embodiment, the system includes a database of inventors in a technology field; and a baseline generator for providing a baseline frequency of technical publications published or applied (submitted) by each inventor in the database for a specified time period. The system may further include a counter for determining from technical publications whether there is an increase in technical publications for at least one of the inventors in the database of inventors in the technological field. The system may further include a comparison module for determining whether the increase in the publications have technology subgroups with a frequency that is greater than a target trend frequency that indicates a technical subgroup as a trend.

In yet another embodiment, a non-transitory computer readable storage medium is provided that includes a computer readable program for determining a technology trend, wherein the computer readable program when executed on a computer causes the computer to perform the steps of analyzing for each inventor of a plurality of inventors in a technology field, a time series of publication dates or application dates for technical documents in the technology field to provide a baseline of technical documents published in a time period. The steps performed by the computer may further include detecting a number of technical document publications having at least one inventor in the plurality of inventors in the technology field, and comparing the number of technical document publications to the baseline of technical documents published in the time period. If the technical document publications exceed the baseline of technical documents, the number of technical document publications that are trending. The method further includes performing a comparative analysis of the content for the technical document publications that are trending to determine a measurement of similarity in technical field subgroups described in the technical document publications that are trending, and extracting trending technical subgroups from the technical document publications that are trending with a degree of similarity above a threshold as a technical group that is a trend.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram depicting one embodiment of a method for detecting important technologies in a technological field, in accordance with one embodiment of the present disclosure.

FIG. 2 shows an exemplary processing system to which the present principles may be applied, in accordance with an embodiment of the present principles.

FIG. 3 is a block diagram illustrating an exemplary system for detecting important technologies in a technological field, in accordance with an embodiment of the present principles.

FIG. 4 depicts a cloud computing node according to an embodiment of the present disclosure.

FIG. 5 depicts a cloud computing environment according to an embodiment of the present disclosure.

FIG. 6 depicts abstraction model layers according to an embodiment of the present disclosure.

### DETAILED DESCRIPTION OF PREFERRED EMBODIMENTS

Detailed embodiments of the claimed methods, structures and computer products are disclosed herein, however, it is to be understood that the disclosed embodiments are merely illustrative of the claimed structures and methods that may be embodied in various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure. Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

Many companies analyze patents to determine their technical strategies. Especially it is widely recognized that in a competitive industry early detections of rising important technologies from other companies can be useful. Published patents and patent applications are available with time lag after applying. For example, in the Unites States a patent application typically publishes 18 months after patent filing (there are exceptions), and in Japan the average time lag is about 1.5 years.

Although the present disclosure is suitable for all technical documents, the methods, systems and computer program products that are disclosed herein are particularly suitable for patent publications, i.e., the publication of patent applications. The methods, systems and computer program products disclosed herein may also analyze granted patents, but it has been determined that for early detection of rising technologies it can be best to analyze patent applications right after they publishing and are available to the public. Previous attempts to evaluate the importance of the patents rely upon information such as citation counts, appeals against decision of rejection, or invalidation trials. This type of information is not available right after the publishing, and the number of patents with such information attached can be quite limited. Scoring methods that utilize those features originally attached to patents (ex. number of claims, whether it is an international application or not, whether the inventors claim internal priority or not, text features of the application, etc) are also proposed. It has been determined that these features do not necessarily illustrate whether a patent publication is technically important.

It has been determined that the inventors of an important technology. e.g., technology subgroup, are typically included as the inventor on numerous related or similar patent applications that are filed, applied for (or published) with a patent office, e.g., United States Patent Office (USPTO) or Japanese Patent Office (JPO), within a short time period of one another. Because in some instances the publication date for the patent application is typically a set term measured from the patent application filing date, the publication dates of patent applications filed in close proximity to one another will also be published within close proximity to one another. In some embodiments, the filing date (also referred to as application date) provides the date for the analysis of the number of patent applications attributed to an inventor. This is mainly is because the applicants for the patent applications try to secure wide rights, to secure license fees for possibly important technologies. One reason for this phenomenon is divisional applications (those applications that are divided after publishing original applications mainly due to secure multiple rights), but there are also many cases without divisional applications. The methods, systems and computer program products of the present disclosure consider both the scenario of new applications in combination with divisionals of the new applications, and the scenario of just new applications without the related divisionals.

It has been determined that to analyze such phenomenon, i.e., analyzing multiple applications being filed or applied for in close time proximity to related technologies, beginning the analysis with the filing conduct of the inventors in a particular technology can highly effective, because cores of a technology are often attached to individual persons.

In the present disclosure, a method, system and computer program product is proposed to extract such similar patents that are localized in the time zone by trend analysis, and enables to detect important technologies in their early stage. The concepts disclosed herein extract a much smaller granularity of data than prior methods, in which the data extracted includes a relatively small number of similar patents for each inventor that is being analyzed. In some embodiments, the present disclosure provides for extraction of important patents from published patent applications using trend analysis. In some embodiments, the present disclosure proposes a method to detected important technologies by analyzing an inventor's publication trend, i.e., the trend by which patent application publish having the inventor listed as an inventor, and exploiting the similarities of patents that are localized in application dates.

In some examples, the mechanism for detecting important technologies in a technological field from published technical documents, in accordance with the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Therefore, in some embodiments, the computer readable storage medium may be referred to as being “non-transitory”.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

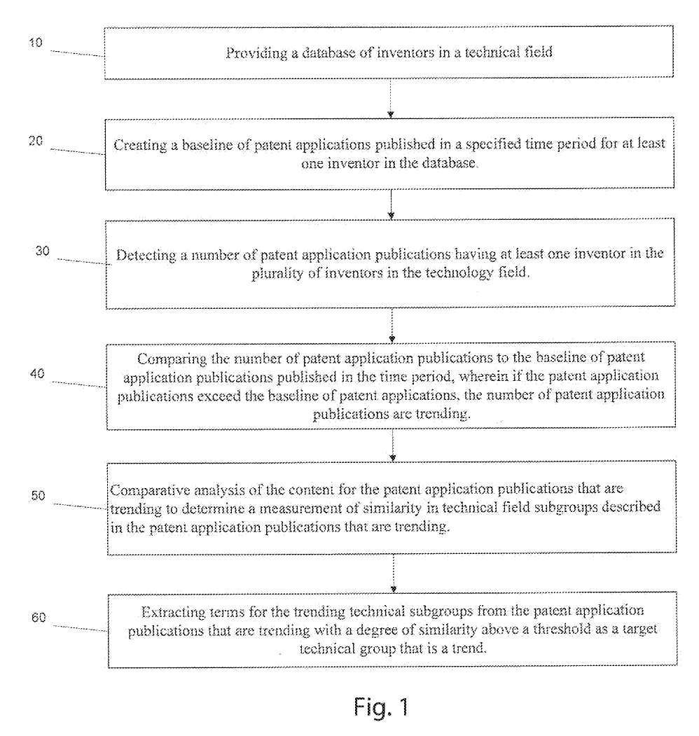

FIG. 1 is a block/flow diagram depicting one embodiment of a method for detecting important technologies in a technological field. In one embodiment, the method includes extracting from technical documents an increasing technology trend in a technology field by determining from a plurality of inventors in the technology field a frequency of new applications filed in a technology subgroup having proximate filing dates. The term “technical document” as disclosed herein refers to a document that describes a type of technology that has been published on behalf of an inventor for that technology. The description typically includes a textual portion that describes the technology. Typically, the technical document is a patent document. The patent document may be a published patent application (that is published by at least one patent office from at least one jurisdiction in the world) or a granted patent (in at least one jurisdiction in the world). In some embodiments, a patent application is a request pending at a patent office for the grant of a patent for the invention described and claimed by that application. The patent application may be a non-provisional patent application, a utility patent application, patent application filed under to provisions of the patent cooperation treaty (PCT), a plant patent application, a design patent, a patent for industrial design, and combinations thereof. It is noted that the above examples of patent applications are provided for illustrative purposes only, and is not intended to limit the present disclosure, as other types of patent applications are equally applicable to the methods, systems and computer program products that are disclosed herein. A patent application has at least one inventor. Although, the patent application describes technology that is intended to be patentable by the inventors, it is not necessary that the subject matter be found to be patentable for the patent application to apply to the methods, systems and computer program products disclosed herein.

The term “publication” means that the technical document, e.g., patent application, has been published so that it can be viewed by a person of the public, i.e., additional to the inventors. Typically, patent applications are first published in the patent office, in which they are first filed. The patent office may be any patent office, such as the United States Patent Office (USPTO) or the Japanese Patent Office (JPO). These are examples of national patent offices, but other patent offices, such as the World Intellectual Property Organization, which typically publishes Patent Cooperation Treat (PCT) applications, can also provide the technical publications being analyzed in the methods, systems and computer program products of the present disclosure. The “publication date” being tracked by the methods and systems of the present disclosure may be the date that the patent application published or in some embodiments may be the application date, i.e., filing date, of the patent application that has published.

In one embodiment, the method includes extracting a technology trend that includes analyzing for each inventor of a plurality of authors in a technology field, a time series of submitting dates for technical documents in the technology field to provide a baseline of applications filed in a time period.

Referring to step 10 of FIG. 1, the method may begin with providing a database of inventors from a particular field. The term “inventor” denotes a person that invented the subject matter of patent application, i.e., published patent application. The inventor is typically listed on the patent application. In some instances, the inventor is included in the text or file history of the patent application as the inventor, or as the applicant of the patent application. In some instances, the inventor may be listed on the patent application as the assignee, or can be an assignor. The “technical field” of interest can be any engineering or scientific field, in which patents are filed. In one embodiment, the technical field may be provided by the International Patent Classification system (IPC). In one example, the technical field may be one class from the international patent classification system (IPC). In another example, the technical field may be one subclass from the international patent classification system. In one embodiment, the technical field may be one of the classes from the United States Patent Classification System (USPC). For example, the technical field may include at least one subclass the United States Patent Classification System (USPC). It is noted that any patent classification system for any patent office in any country that publishes patent applications may provide the fields for the technical field. Further, it is not necessary that the technical field be defined by an existing patent classification system. A set of keywords may also work as a query to define a technical field. For example, examples of engineering and science disciplines that can provide classification for the technical field can include chemistry, such as, materials chemistry, biotechnology, chemical engineering, environmental technology, food chemistry, macromolecular chemistry, polymers, metallurgy and materials, microstructural materials, nanotechnology, organic fine chemistry, pharmaceuticals, surface treatment technology, and surface coatings, electrical engineering, such as audio-visual technology, communication processes, computer technology, digital communication, electrical machinery, apparatus, energy, IT methods for management, semiconductors, and telecommunications; instruments, such as analysis of biological materials, control, measurement, medical technology, and optics; mechanical engineering, such as engines, pumps, turbines, handling, machine tools, mechanical elements, textile and paper machines, thermal processes and apparatus, and transport; and other fields, such as civil engineering and consumer goods.

The selection of inventors may be based upon known frequency of being an inventor on patent application within a particular technical field and/or known employment or association with a business, research facility or education institution having a presence in the technical field of interest. Any number of inventors may be included in the database. For example, the number of inventors that are included in the database may range from 2 to 1000. In another example, the number of inventors that is included in the database ranges from 5 to 500. In yet another example, the number of inventors that is included in the database ranges from 10 to 100. It is noted that the above examples of how the inventors for the database are selected, and the number of inventors that are included in the database are provided for illustrative purposes only, and are not intended to limit the teachings of the present disclosure. For example, any number of inventors may be included in the database.

Following generation of the database of inventors in the technical field, the method continues with creating a baseline of patent applications published in a specified time period for at least one inventor in the database at step 20 of the method depicted in FIG. 1. As noted above, the present disclosure provides a method to detect important technologies in a technical field by analyzing each inventor's trend in a time period, and exploiting the similarities of patents that are localized in patent application dates. This analysis can begin with from a specific technical field, analyzing each inventor's time series with published application dates, e.g., filing dates of patent applications, or publication dates of patent applications, as a time axis, and detecting the events that the number of patents increases anomalously in a short time. In one embodiment, the method can include creating a time-series model like a Poisson process for number of applications of each inventor at step 20. A “Poisson process” is a stochastic process, i.e., having a random probability distribution or pattern that may be analyzed statistically, that is defined in terms of the occurrence of events. This time-series model, e.g., Poisson process, may be created for the number of applications published in a time period for each inventor of the plurality of inventors in the specified technical field of the database provided in step 10.

The expected value of patent applications published for each inventors that is provided by the respective time-series models, e.g., Poisson process models, may then be compared with an actual value of the patent applications published per inventor to determine if the number of technical document publications being published by at least one of the inventors may be the result of a trending event, i.e., whether the number of technical document publications for the inventor are trending. The time period that is considered for the number of patent applications that publish for each inventors in the database for producing the baseline may range from 1 week to 2 years. In some embodiments, the time period that is considered for that publish for each inventors in the database for producing the baseline may range from 1 month to 1 year. It is noted that the above examples of time period in which patents are published for the inventors for producing the baseline are provided for illustrative purposes only, and are not intended to limit the teachings of the present disclosure.

At step 30, a counter may detect a number of technical document publications having at least one author in the plurality of authors in the technology field. The counter may detect the number of published patent applications listing one of the inventors, as well as the technical field of the published patent applications, as the published patent applications are being published. For example, the patent applications may be published by a patent office, such as the USPTO, the JPO, the WIPO or a combination thereof. The time period for counting the number of technical document publications being published for each inventor in the database may range from 1 week to 2 years. In some embodiments, the time period that is considered for that publish for each inventors in the database for producing the baseline may range from 1 month to 1 year. It is noted that the above examples of time period in which patents are published for the inventors for producing the baseline are provided for illustrative purposes only, and are not intended to limit the teachings of the present disclosure. In some embodiments, the time period for the counter to detect the number of technical document publications having at least one author in the plurality of authors in the technology field is published is equal to the time period for determining the baseline. In some other embodiments, the time period for the counter to detect the number of technical document publications having at least one author in the plurality of authors in the technology field is published is different from the time period for determining the baseline. For example, the time period for the counter to detect the number of technical document publications having at least one author in the plurality of authors in the technology field is published may be more than or less than the time period for determining the baseline.

At step 40 of the method depicted in FIG. 1, the number of technical document publications may be compared with the baseline of technical documents filed in the time period. If the technical document publications exceed the baseline of technical documents, the number of technical document publications is trending. For example, baseline of patent applications published in a specified time period for at least one inventor in the database at step 20 can be provided by a score s, which can be provided by Equation (1), as follows:

s=−log P(x0) Equation (1)

wherein P(x) is a probability modeled by Poisson distribution P(x), which is modeled using the average number of applications per month for an inventor, and x0 is an observed number of applications at a month for the inventor. Using this method, when a high score s is calculated, an unexpectedly high number of patent applications per month have been published for at least one inventor in the database in a short time. An example of an increased number of patent publications that would trigger a high score for Equation (1) may be an increase of 25% or more in patent application publications in comparison to the baseline per substantially the same period of time. In another example, of an increased number of patent publications that would trigger a high score for Equation (1) may be an increase of 50% or more in patent application publications in comparison to the baseline per substantially the same time period.

A high score as explained above with reference to Equation (1) that indicates an increase in patent publication frequency for an inventor may indicate a number of technical document publications that are trending. This means that the increased number of technical documents, i.e., patents, that are publishing may be filed on a related technology type, which could be indicative of a trend towards developing a new technology type. This could represent that the technical documents that triggered the increase in publications be examined for similarities.

It is noted that the above example is only one example of how the number of technical document publications may be compared with the baseline of technical documents filed in the time period at step 40. Another example of how the number of technical documents, e.g., patent application publications, for an inventor may be compared to the base line may include building another model using exponential distribution to predict the time span between the nearest publication dates for patent applications published for an inventor from the database. In yet another example, it can be possible to detect outliers by supposing a static state.

Referring to FIG. 1, the method may continue if the number of technical publications supports a possible trend at step 50. Step 50 of the method in FIG. 1 may include comparative analysis of the content for the technical document publications, e.g., patent application publications, which are trending to determine a measurement of similarity in technical field subgroups that are described in the technical document publications that are trending. Technical field subgroups may include a type of technology within the technical field. For example, if the technical field of the database of inventors is metals, examples of technical field subgroups may include steel, aluminum and titanium. For example, if the technical field of the database of inventors is directed to nanotechnology, examples of technical field subgroups may include carbon nanotubes, carbon fullerenes, inorganic fullerenes, inorganic nanotubes and combinations thereof. In yet another example, if the technical field of the database is semiconductors, technical field subgroups may include type IV semiconductor, type III-V semiconductors, planar field effect transistors, fin type field effect transistors, low voltage transistor, high voltage transistors, etc.

In one embodiment, when the large score s is detected (that is, unexpectedly large number of patents are applied in a short time), the process may continue with calculating the similarities between those patents at step 50 with extracting a subgroup of patent application publications within which the similarity is above a predetermined threshold value. The threshold value can be determined by comparing a similarity value of randomly picked patents in a technical field and that of known similar patents. In some embodiments, extracting a subgroup of the patent applications can include calculating KL divergence of unigram model. The Kullback-Leibler divergence (also information divergence, information gain, relative entropy, or KLIC; here abbreviated as KL divergence) is a non-symmetric measure of the difference between two probability distributions P and Q. One example of KL divergence includes

$$( KLD ( P ‖ Q ) = {\sum }_{i} P ( {x}_{i} ) log \frac{P ( {x}_{i} )}{Q ( {x}_{i} )} ) .$$

In another embodiment, extracting subgroup of patent applications consistent with step 50 of the method depicted in FIG. 1 may include calculating cosine similarity in accordance with a bag of words model. Other approaches are extracting a subgroup of patents which contains the same characteristic keywords of the group derived, for example by Pointwise Mutual Information (PMI). Pointwise mutual information (PMI), or point mutual information, is a measure of association used in information theory and statistics, which typically refers to single events.

In one embodiment, the comparative analysis of the content for the trending technical documents to determine a measurement of similarity in technical field subgroups at step 50 may include identifying a keyword as a keyword indicating an important technology from the extracted group of technical documents by using a predetermined index. For example, when searching in a technical field for semiconductors a keyword may be FinFET.

Referring to FIG. 1, the method may continue at step 60, which includes extracting terms for the trending technical subgroups from the technical document publications that are trending with a degree of similarity above a threshold as a target technical group that is a trend. The terms may be extracted into an index using methods, such as Term Frequency-Inverse Document Frequency (TFIDF) or Pointwise Mutual Information (PMI) or a combination thereof. Term Frequency-Inverse Document Frequency (TFIDF) is a numerical statistic that is intended to reflect how important a word is to a document in a collection. The terms extracted may provide a description of the trending technical subgroups.

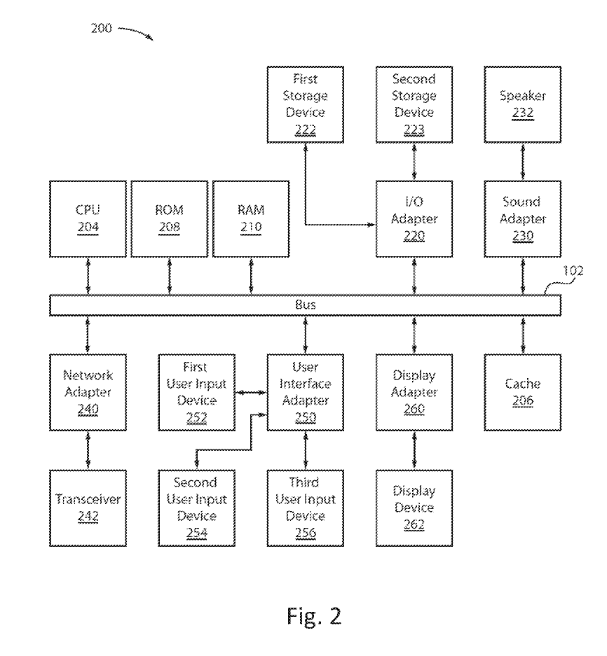

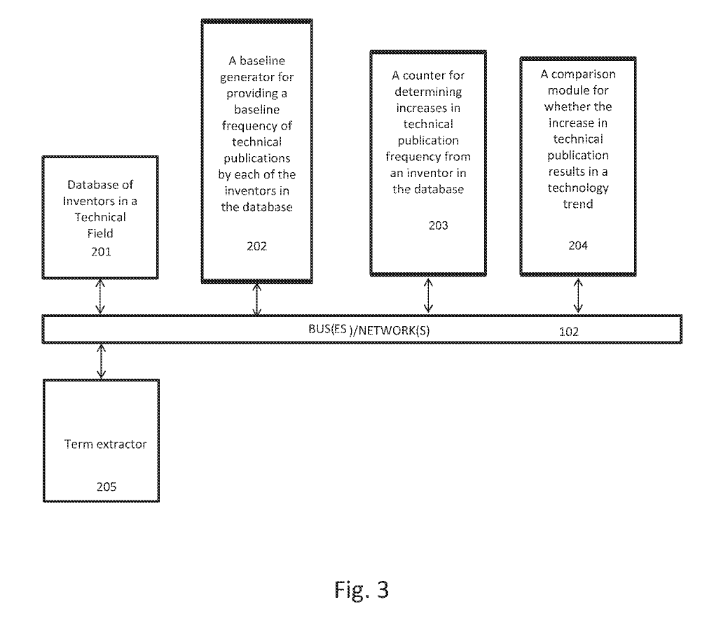

Referring to FIGS. 2 and 3, in accordance with another aspect of the present disclosure, a system is provided for detecting trends from technical documents, e.g., patent applications, which are published by specific inventors. In one embodiment, the system includes a database of inventors 201 in a technology field, and a baseline generator 202 for providing a baseline frequency of technical publications by each of the inventors in the database. The system further includes a counter 203 for determining increases in technical publication frequency by each of the inventors in the database. The system further includes a comparison module 204 may then determine whether the publications of the trending technology event have technology subgroups with a frequency that is greater than a target trend frequency. The technology subgroups with a frequency that is greater than a target trend frequency are a target technical group that is a newly trending technology. In some embodiments, the system 200 may further include a term extractor 205.

FIG. 2 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152.154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

Moreover, it is to be appreciated that system 200 described below with respect to FIG. 2 is a system for implementing respective embodiments of the present principles. Part or all of processing system 100 may be implemented in one or more of the elements of system 200. Further, it is to be appreciated that processing system 100 may perform at least part of the method described herein including, for example, at least part of method of FIG. 1.

FIG. 3 shows an exemplary system 200 for a determining technology trends from technical documents that are published, in accordance with an embodiment of the present principles. The system 200 includes a database 201 of inventors in a technology field; a baseline generator 202 for providing a baseline frequency of technical publications by each of the inventors in the database; a counter 203 for determining increases in technical publication frequency by each of the inventors; and a comparison module 204 for determining whether the publications of a trending event have technology subgroups with a frequency that is greater than a target trend frequency. In some embodiments, each of the database 201, the baseline generator 202, the counter 203, the term extractor 205 and the comparison module 204 may include one or more modules of memory including a set of instructions and/or data to be executed by a hardware processor.

In the embodiment shown in FIG. 2, the elements thereof are interconnected by bus(es)/network(s) 102. However, in other embodiments, other types of connections can also be used. Moreover, in an embodiment, at least one of the elements of system 200 is processor-based, e.g., hardware processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of system 200 are readily determined by one of ordinary skill in the art, given the teachings of the present principles provided herein, while maintaining the spirit of the present principles.

In some embodiments, the database 201 of inventors in a technology field can perform the function of step 10 of the method described in the flow chart depicted in FIG. 1. Therefore, further description of the database 201 may be provided by the description of step 10 in FIG. 1. The baseline generator 202 for providing a baseline frequency of technical publications by each of the inventors in the database can function to provide the function of step 20 of the method described in the flow chart depicted in FIG. 1. Therefore, further description of the baseline generator 202 may be provided by the description of step 20 in FIG. 1, which includes creating a baseline of patent applications published in a specified time period for at least one of the inventors in the database 201. The counter 203 for determining increases in technical publication frequency by each of the inventors that is depicted in FIG. 3 may perform the step of detecting a number of patent application publications having at least one inventor in the database 201, as described with reference to step 30 of FIG. 1. The comparison module 204 that determines whether the publications of a trending event have similar technology subgroups with a frequency indicative of a target trend frequency has been further described with reference to steps 40 and 50 of the method described above with reference to FIG. 1. In some embodiments, the system may further include a term extractor 205. The term extractor 205 provides an index of terms for technology subgroups that are trending. The function of the term extractor 205 has been further described with reference to step 60 of the method illustrated in FIG. 1.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

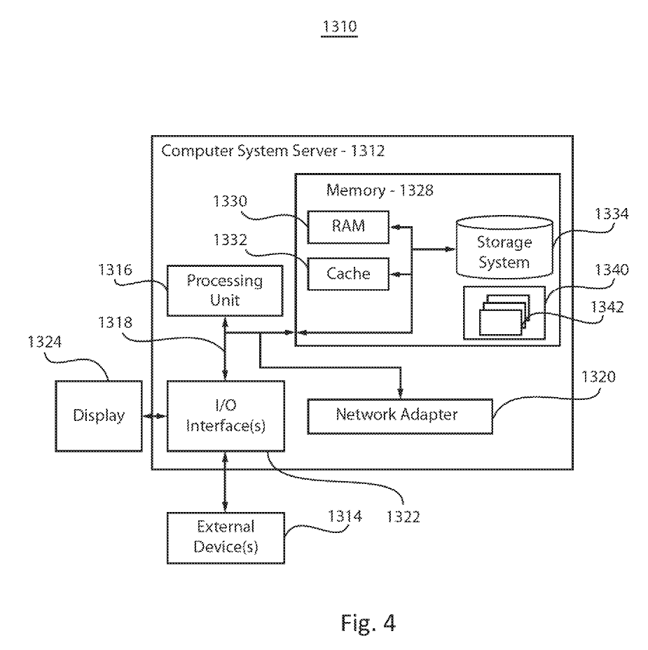

Referring now to FIG. 4, a schematic of an example of a cloud computing node 1310 is shown. Cloud computing node 1310 is only one example of a suitable cloud computing node and is not intended to suggest any limitation as to the scope of use or functionality of embodiments of the invention described herein. Regardless, cloud computing node 1310 is capable of being implemented and/or performing any of the functionality set forth hereinabove.

In cloud computing node 1310 there is a computer system/server 1312, which is operational with numerous other general purpose or special purpose computing system environments or configurations. Examples of well-known computing systems, environments, and/or configurations that may be suitable for use with computer system/server 1312 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1312 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1312 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 1312 in cloud computing node 1310 is shown in the form of a general-purpose computing device. The components of computer system/server 1312 may include, but are not limited to, one or more processors or processing units 1316, a system memory 1328, and a bus 1318 that couples various system components including system memory 1328 to processor 1316.

Bus 1318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1312 typically includes a variety of computer system readable media. Such media may be any available media that is accessible by computer system/server 1312, and it includes both volatile and non-volatile media, removable and non-removable media.

System memory 1328 can include computer system readable media in the form of volatile memory, such as random access memory (RAM) 1330 and/or cache memory 1332. Computer system/server 1312 may further include other removable/non-removable, volatile/non-volatile computer system storage media. By way of example only, storage system 1334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1318 by one or more data media interfaces. As described above, memory 1328 may include at least one program product having a set (e.g., at least one) of program modules that are configured to carry out the functions of embodiments of the present disclosure, as described with reference to FIGS. 1-3.

Program/utility 1340, having a set (at least one) of program modules 1342, may be stored in memory 1328 by way of example, and not limitation, as well as an operating system, one or more application programs, other program modules, and program data. Each of the operating system, one or more application programs, other program modules, and program data or some combination thereof, may include an implementation of a networking environment. Program modules 1342 generally carry out the functions and/or methodologies of embodiments of the invention as described herein. For example, the program modules 1342 can include the modules described with reference to FIG. 3, e.g., the modules for the database 201, the baseline generator 202, the counter 203, the term extractor 205 and the comparison module 204.

Computer system/server 1312 may also communicate with one or more external devices 1314 such as a keyboard, a pointing device, a display 1324, etc.; one or more devices that enable a user to interact with computer system/server 1312; and/or any devices (e.g., network card, modem, etc.) that enable computer system/server 1312 to communicate with one or more other computing devices. Such communication can occur via Input/Output (I/O) interfaces 1322. Still yet, computer system/server 1312 can communicate with one or more networks such as a local area network (LAN), a general wide area network (WAN), and/or a public network (e.g., the Internet) via network adapter 1320. As depicted, network adapter 1320 communicates with the other components of computer system/server 1312 via bus 1318. It should be understood that although not shown, other hardware and/or software components could be used in conjunction with computer system/server 1312. Examples, include, but are not limited to: microcode, device drivers, redundant processing units, external disk drive arrays, RAID systems, tape drives, and data archival storage systems, etc.

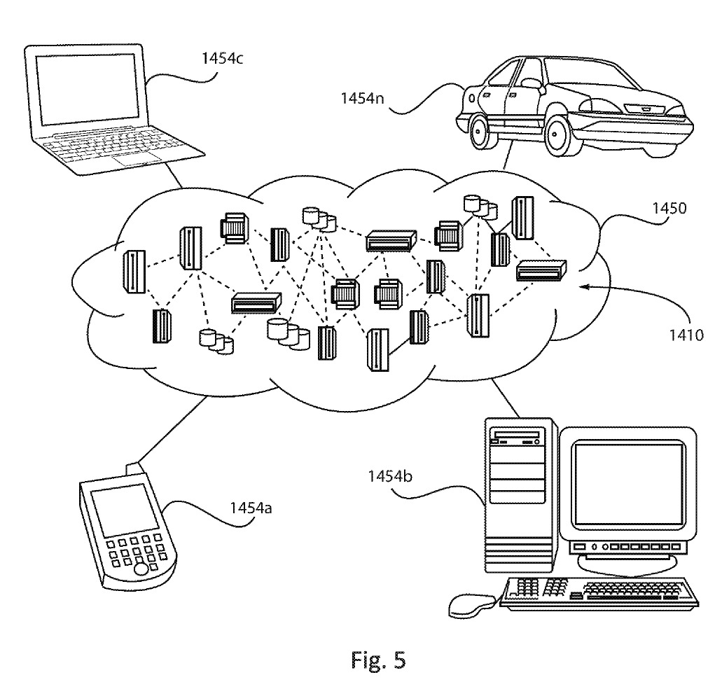

Referring now to FIG. 5, illustrative cloud computing environment 1450 is depicted. As shown, cloud computing environment 1450 comprises one or more cloud computing nodes 1410 with which local computing devices used by cloud consumers, such as, for example, personal digital assistant (PDA) or cellular telephone 1454A, desktop computer 1454B, laptop computer 1454C, and/or automobile computer system 1454N may communicate. Nodes 1410 may communicate with one another. They may be grouped (not shown) physically or virtually, in one or more networks, such as Private, Community, Public, or Hybrid clouds as described hereinabove, or a combination thereof. This allows cloud computing environment 1450 to offer infrastructure, platforms and/or software as services for which a cloud consumer does not need to maintain resources on a local computing device. It is understood that the types of computing devices 1454A-N shown in FIG. 5 are intended to be illustrative only and that computing nodes 1410 and cloud computing environment 1450 can communicate with any type of computerized device over any type of network and/or network addressable connection (e.g., using a web browser).

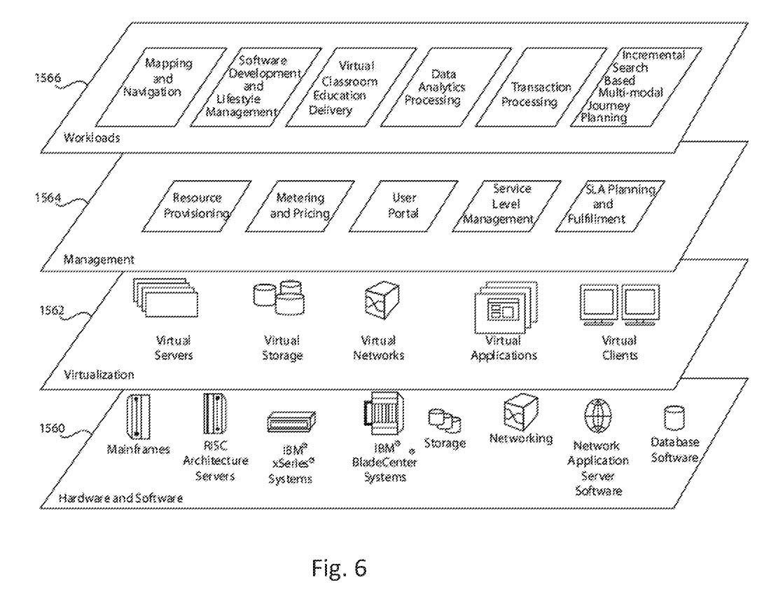

Referring now to FIG. 6, a set of functional abstraction layers provided by cloud computing environment 1550 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1560 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1562 provides an abstraction layer from which the following examples of virtual entities may be provided: virtual servers; virtual storage; virtual networks, including virtual private networks; virtual applications and operating systems; and virtual clients.

In one example, management layer 1564 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1566 provides examples of functionality for which the cloud computing environment may be utilized.

Examples of workloads and functions which may be provided from this layer include: mapping and navigation; software development and lifecycle management; virtual classroom education delivery; data analytics processing; transaction processing; and measuring technology trends in accordance with the method described in FIG. 1.

Having described preferred embodiments of a system and method and computer program product for determining trends in patented technology, it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for measuring technology trends comprising:
analyzing for each inventor of a plurality of inventors in a technology field, a time series of publication dates for technical documents in the technology field to provide a baseline of technical documents published in a time period;
detecting with a hardware processor based counter a number of technical document publications having at least one inventor in the plurality of inventors in the technology field;
comparing the number of technical document publications to said baseline of technical documents filed in the time period, wherein if the technical document publications exceed the baseline of technical documents, the number of technical document publications are trending;
performing a comparative analysis of the content for the technical document publications that are trending to determine a measurement of similarity in technical field subgroups described in the technical document publications that are trending; and
extracting trending technical subgroups from the technical document publications that are trending with a degree of similarity above a threshold as a technical subgroup that is a trend.

2. The method of claim 1, wherein the technical documents are patent applications published by a patent office.

3. The method of claim 1, wherein the technology field is selected from the classification system of a patent office.

4. The method of claim 1, wherein said detecting with a hardware processor based counter an increase in a number of publications of trending technical documents includes building a time-series model for the number of technical documents of each inventor and comparing an expected value with an actual value.

5. The method of claim 4, wherein the time-series model includes a Poisson process.

6. The method of claim 5, wherein said comparing the number of technical document publications to said baseline of technical documents filed in the time period calculating a score s from:
S=−log(Px0)
wherein P(x) is a distribution of a Poisson process modeled using an average number of patent applications published per month for said each inventor of said plurality of inventors in said technology field, and x0 is an observed number of patent applications published per month for said each inventor of said plurality of inventors in said technology field.

7. The method of claim 1, wherein said comparative analysis of the content for the trending technical documents to determine a measurement of similarity in technical field subgroups described in the trending technical documents further comprises identifying a keyword as a keyword indicating a trending technology from an extracted subgroup of technical documents by using an index.

8. The method of claim 5, wherein the comparative analysis comprises Kullback-Leibler divergence, Pointwise Mutual Information (PMI) or a combination thereof.

9. The method of claim 1 further comprising providing an index of terms for said technology subgroups that are trending.

10. The method of claim 9, wherein providing the index comprises Term Frequency-Inverse Document Frequency (TFIDF), Pointwise Mutual Information (PMI) or a combination thereof.

11. A system for detecting technology trends comprising:
a database of inventors in a technology field;
a baseline generator for providing a baseline frequency of technical publications published by each inventor of said database for a specified time period;
a counter for determining from technical publications whether there is an increase in technical publications for at least one of the inventors in the database of inventors in the technological field; and
a comparison module for determining whether the technical publications providing the increase in the technical publications have technology subgroups with a frequency that is greater than a target trend frequency that indicates a technical subgroup as a trend.

12. The system of claim 11, wherein the technical documents are patent applications published by a patent office.

13. The system of claim 11, wherein the technology field is selected from the classification system of a patent office.

14. The system of claim 11, wherein the counter detects an increase in a number of publications by creating a time-series model for the number of technical documents of each inventor and comparing an expected value of technical publication with an actual value of technical publications.

15. The system of claim 14, wherein said creating the time-series model includes a Poisson process.

16. The system of claim 15, wherein said comparing the number of expected technical document publications to the actual technical documents published in the time period calculating a score s from:
S=−log(Px0)
wherein P(x) is a distribution of a Poisson process modeled using an average number of patent applications published per month for said each inventor of said plurality of inventors in said technology field, and x0 is an observed number of patent applications published per month for said each inventor of said plurality of inventors in said technology field.

17. The system of claim 15, wherein said comparison module performs a comparative analysis of the content for the technical publications to determine a measurement of similarity in technical field subgroups described that comprises identifying a keyword as a keyword indicating an extracted subgroup of technical documents by using an index.

18. The system of claim 15, wherein the comparison module performs a comparative analysis comprising Kullback-Leibler divergence, Pointwise Mutual Information (PMI) or a combination thereof.

19. The system of claim 15 further comprising a term extractor that provides an index of terms for technology subgroups that are trending.

20. A non-transitory computer readable storage medium comprising a computer readable program for determining technology trends, wherein the computer readable program when executed on a computer causes the computer to perform the steps of:
analyzing for each inventor of a plurality of inventors in a technology field, a time series of publication dates for technical documents in the technology field to provide a baseline of technical documents published in a time period;
detecting with a counter a number of technical document publications having at least one inventor in the plurality of inventors in the technology field;
comparing the number of technical document publications to said baseline of technical documents published in the time period, wherein if the technical document publications exceed the baseline of technical documents, the number of technical document publications are trending;
performing a comparative analysis of the content for the technical document publications that are trending to determine a measurement of similarity in technical field subgroups described in the technical document publications that are trending; and
extracting trending technical subgroups from the technical document publications that are trending with a degree of similarity above a threshold as a technical subgroup that is a trend.
